(19) United States
(12) Patent Application Publication
(10) Pub. No.: US 2013/0276069 A1
(43) Pub. Date: Oct. 17, 2013

(54) INTERNET IDENTITY MANAGEMENT

(71) Applicant: Socialogue, Inc., Petaluma, CA (US)

(72) Inventors: Charles Roberson, Sonoma, CA (US); David Hillard, Petaluma, CA (US); Edgar Abadines, Petaluma, CA (US)

(21) Appl. No.: 13/831,072

(22) Filed: Mar. 14, 2013

Related U.S. Application Data
(60) Provisional application No. 61/614,460, filed on Mar. 22, 2012.
(60) Provisional application No. 61/716,323, filed on Oct. 19, 2012.

(51) Int. Cl. H04L 29/06

(52) U.S. Cl. CPC H04L 63/08
USPC 726/4

(57) ABSTRACT

Provided are systems and methods method for management of identity and relationships and more particularly to methods and systems for establishing and verifying the authority of a point of presence (POP) or another identity on the web to affirm a representation of an entity or individual.

### CROSS-REFERENCE TO RELATED APPLICATIONS

This application claims the benefit under 35 U.S.C. §119(e) to U.S. Provisional Application Ser. Nos. 61/614,460, filed Mar. 22, 2012, and 61/716,323, filed Oct. 19, 2012, the contents of each of which are incorporated by reference in its entirety into the present disclosure.

### FIELD OF THE DISCLOSURE

The present disclosure generally relates to the management of identity and relationships and more particularly to methods and systems for establishing and verifying the authority of a point of presence (POP) or another identity on the web to affirm a representation of an entity or individual.

### BACKGROUND

An entity, such as an individual, a business and other types of organizations, often has multiple points of presence (POP) on the web or in other types of existence (e.g., phone number, address, registration number) to represent the entity and the associated projects, products, brands, organizational units, etc. Each POP is a distinct page, identifiable via, for instance, a Universal Resource Indicator (URI), on a service provider's platform (e.g. a web host, a media host, a social network, etc.). Many providers have established proprietary rules for defining user names or URI and employ custom procedures for accessing (e.g. application programming interfaces) elements of those points of presence.

The use of these various platforms utilizing non-standard rules and procedures in the same organization can lead to consistency and integrity problems. A single entity represented on more than one POP can lead to variations in the representation that dilute, fragment, or worse, misrepresent an identity (e.g. brand) (see, e.g., FIG. 1). To date, there is no system to integrate and centrally manage one's identity/(ies) globally across the web.

Additionally, there is no holistic system for ascertaining whether or not a specific POP authoritatively represents an individual or brand. The lack of such a system makes current identity/brand owners subject to negative effects by counterfeit POPs. Also, it often leaves the burden of proving the authenticity up to the individual web user who is visiting the POP.

Lastly, an identity is not only affected by its own (and counterfeit) POPs on the web but its relationships to other identities and POPs on the web. Currently, individuals and entities rely on ad hoc methods fir making and verifying the claims made between two entities. Such methods include public services where people can make assertions about specific relationships that may not be verifiable or true, as well as the management of distinct lists of relationships by each individual or entity that are hosted and managed by that individual or entity.

Thus, a simple and cost-effective technique for establishing and verifying an entity's identity, the authority of specific POP to represent that identity and the authorized relationships that may exist between those distinct identities from time to time is highly desirable.

### SUMMARY

Provided, in some embodiments, is a method for authenticating a query internet identifier, comprising: receiving, at a server, an inquiry comprising a query internet identifier, checking the query internet identifier against a database that (a) comprises a plurality of entity identifiers each representing a real world entity and (h) associates each of the plurality of entity identifiers to at least an internet identifier determining whether the query internet identifier matches one of the internet identifiers in the database. In one aspect, the method further comprises returning a result indicating that the query internet identifier matches an internet identifier in the database thereby authenticating the query internet identifier as associated with the corresponding real word entity.

Some embodiments provide a computer-readable non-transitory medium comprising program code which, when executed, displays a link in a web content, wherein the web content is presented in an internet program and is identified by an internet identifier and wherein the link is configured to send an inquiry to determine whether the internet identifier is associated with a real world entity.

Yet some embodiments provide a computer-readable non-transitory medium comprising program code which, when executed, configures a program to determine whether a web content identified by an internet identifier is associated with a real world entity.

Methods are also provided for detecting web content falsely associated with a real world entity comprising scanning, by a server, a web content self-identifying as associated with a designated real world entity checking the internet identifier associated with the web content against a database that (a) comprises a plurality of entity identifiers each representing a real world entity and (h) associates each of the plurality of entity identifiers to at least an internet identifier; determining that the web content falsely identifies itself as associated with the designated real world entity if the designated real world entity matches a real world entity in the database but the internet identifier associated with the web content is not associated with the designated real world entity in the database.

### BRIEF DESCRIPTION OF THE DRAWINGS

Provided embodiments are illustrated by way of example, and not limitation, in the figures of the accompanying drawings in which:

FIG. 1 illustrates internet identities (also termed “point of presence (POP)”) dispersed over the internet;

FIG. 2 shows that, with the systems and methods of the present disclosure, diverse POPs are associated to the corresponding real world entity, represented by an entity identifier (also termed “Brandle”);

FIG. 3 presents a Brandle to POP functional transform;

FIG. 4 presents a POP to Brandle functional transform;

FIG. 5 shows a Brandle+Domain to POP functional transform;

FIG. 6 illustrates a Brandle Family Tree;

FIG. 7 shows a Brandle+Relation to Brandle functional transform;

FIG. 8 shows a Brandle family tree with relationships extended to foreign Brandles;

FIG. 9 shows an exemplary Brandle relationship protocol;

FIG. 10 presents a Brandle to related Brandles functional transform;

FIG. 11 presents a Brandle+Brandle to relationship functional transform;

FIG. 12 presents a Brandle+POP to relationship functional transform;

FIG. 13 shows a POP to Brandle+Relationship chained functional transform;

FIG. 14 illustrates that an entity can have multiple, independent Brandles;

FIG. 15 shows a sub-Brandle as a relative persona;

FIG. 16A-B illustrate the use of a hash modifier (16A) or Brandle (16B) as a persona of a parent Brandle;

FIG. 17A-B illustrate Brandle family tree relationships. Except for “Owns” relationships, these represent any Brandle-Brandle, User-Brandle, CorpAcct-Brandle, User-Corp Acct relationship. (Examples include: Admin relationships, Certification relationships, Employee Relationships, etc.) (17A). “Owns” Relationships between Brandles, POPs, Corporate Accounts and Users (17B);

FIG. 18 illustrates the pairing of a Brandle family tree and another Brandle;

FIG. 19 illustrates an example Brandle certificate; and

FIG. 20 illustrates an example POP deed.

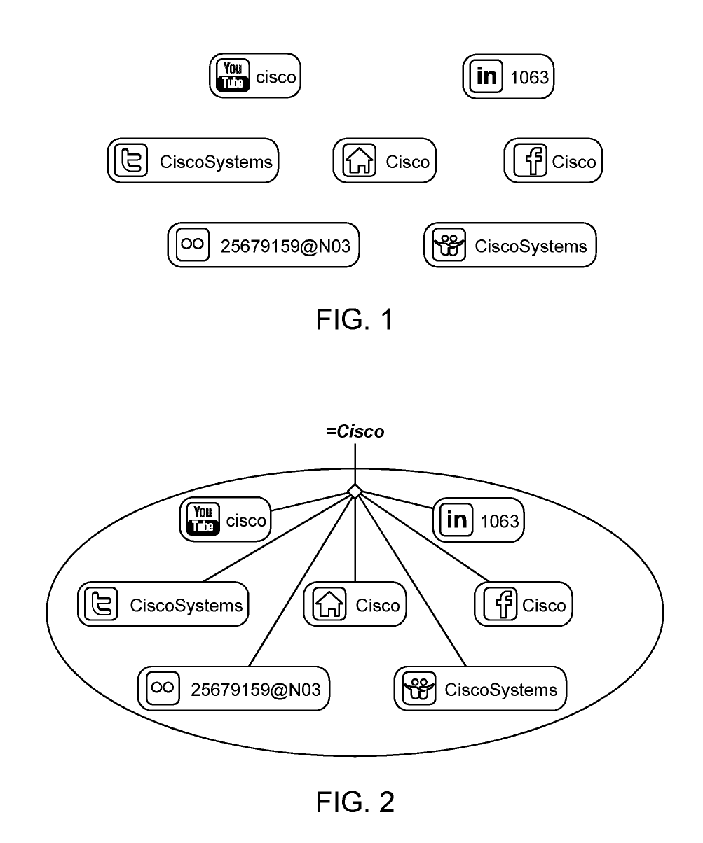

It will be recognized that some or all of the figures are schematic representations for purposes of illustration and do not necessarily depict the actual relative sizes or locations of the elements shown. The figures are provided for the purpose of illustrating one or more embodiments with the explicit understanding that they will not be used to limit the scope or the meaning of the claims.

### DETAILED DESCRIPTION OF THE DISCLOSURE

As used herein, certain terms have the following defined meanings. Terms that are not defined have their art recognized meanings.

As used in the specification and claims, the singular form “a”, “an” and “the” include plural references unless the context clearly dictates otherwise.

As used herein, the term “comprising” is intended to mean that the devices and methods include the recited components or steps, but not excluding others. “Consisting essentially of” when used to define devices and methods, shall mean excluding other components or steps that would materially affect the basic and novel characteristics of the technology. “Consisting of” shall mean excluding any components or steps not specified in the claim. Embodiments defined by each of these transition terms are within the scope of this disclosure.

A “processor” is an electronic circuit that can execute computer programs. Examples of processors include, but are not limited to, central processing units, microprocessors, graphics processing units, physics processing units, digital signal processors, network processors, front end processors, coprocessors, data processors and audio processors.

A “memory” refers to an electrical device that stores data for retrieval. In one aspect, a memory is a computer unit that preserves data and assists computation.

The present disclosure provides systems and methods for defining and using a universally unique identifier for an entity, associating one or more distinct points of presence (POPs) on the internet to that identity, and then defining specific relationships between any two identities. Relationships may take multiple forms but come in two primary classes: internal and external. Internal relationships define identities that are related to one another via shared ownership by a common individual or entity—in the same “corporate family tree”). External relationships are between identities of distinct entities.

Once the distinct identifiers, representing certain entities, are established and linked to their POPs and related identities, the authenticity of a POP to represent an entity or of any foreign identity to affirm an existing relationship to that entity, can be established. By the definition of what is authentic, ascertaining what is not authentic is resolved via the application of set theory.

Accordingly, provided are systems and methods that allow any entity define and manage its identities. POPs, family trees and external relationships. In particular, a global, publicly accessible registry is provided, maintained by the primary system that allows queries to ascertain the pedigree or authenticity of any entity, POP or claimed relationship.

Thus, one embodiment of the present disclosure provides a method for authenticating a query internet identifier, comprising receiving, at a server, an inquiry comprising a query internet identifier, checking the query internet identifier against a database that (a) comprises a plurality of entity identifiers each representing a real world entity and (b) associates each of the plurality of entity identifiers to at least an internet identifier determining whether the query internet identifier matches one of the internet identifiers in the database. In one embodiment, the method further comprises returning a result indicating that the query internet identifier matches an interact identifier in the database thereby authenticating the query internet identifier as associated with the corresponding real word entity.

As used herein, a “real world entity” or simply an “entity” refers to any object of real world existence. Non-limiting examples include individuals, businesses, organizations, government agencies, institutions, programs, groups, societies, projects, products, trademarks and brands. In one aspect, an entity refers to an individual. In another aspect, an entity refers to all other forms of entities described above except an individual.

An “entity identifier” refers to a computational representation of an entity. In one aspect, an entity identifier has an identification number and/or an identification name. In another aspect, an entity identifier can be displayed with an identification number, an identification name, and/or related signed or images. For the purpose of this disclosure, an entity identifier is also termed a “Brandle”, although other types of entity identifiers are contemplated.

The term “internet identifier” refers to an internet address or account that is intended or appears to be associated with an entity. In one aspect, an internet identifier is a domain name, a Universal Resource Indicator or Uniform Resource Identifier (URI), a Universal Resource Locator (URL), or an email address, without limitation. In another aspect, an internet identifier is an account associated with a domain name (e.g., facebook.com) or an internet program (e.g., Facebook®). For the purpose of this disclosure, an internet identifier is also referred to as a Point of Presence (POP), although other types of internet identifiers are contemplated. In some embodiments, an internet identifier (POP) corresponds to a displayed content identifiable by the internet identifier.

### Entity and Internet Identifier Database

Provided in one embodiment is a database (or another type of data structure), which can be embedded in a computer-readable non-transitory medium, that includes attributes and relations suitable for implementing the objective of the methods of any of the above embodiments. In one aspect, the database includes a plurality of entity identifiers each representing an entity. For each entity identifier, the database further includes at least one internet identifier associated with the entity identifier. In some aspects, an internet identifier is associated with a domain name or program, which can be represented by a Brandle. Examples of such entities, entity identifiers and internet identifiers are provided in Table 1 below.

TABLE 1
Examples of entities, entity identifiers and internet identifiers

| | | | | Target |
|---|---|---|---|---|
| | Entity | | | Entity |
| | Identifier | | | Identifier |
| Entity | (Brandle) | Internet Identifier (POP) | Domain | (Brandle) |
| Cisco | =cisco | cisco.com | WWW | — |
| Systems, | | | | |
| Inc. | | | | |
| Cisco | =cisco | facebook.com/cisco | Facebook.com | =facebook |
| Systems, | | | | |
| Inc. | | | | |
| Cisco | =cisco | twitter.com/CiscoSystems | Twitter.com | =twitter |
| Systems, | | | | |
| Inc. | | | | |
| Cisco | =cisco | linkedin/company/cisco- | LinkedIn.com | =linkedin |
| Systems, | | systems | | |
| Inc. | | | | |
| Cisco | =cisco | flickr.com/25679159@N03 | Flickr.com | =flickr |
| Systems, | | | | |
| Inc. | | | | |
| John Smith | =jsmith007 | twitter.com/voiceofsmith | Twitter.com | =twitter |
| John Smith | =jsmith007 | Xbox.com/Smith_the_Warrior | Xbox.com | =xbox |
| Facebook | =facebook | facebook.com | WWW | — |
| Inc. | | | | |

In some embodiments, as illustrated in Table 1, the entity identifier starts with an equal sign to be distinguished from other identity types (e.g., usernames) in common usage.

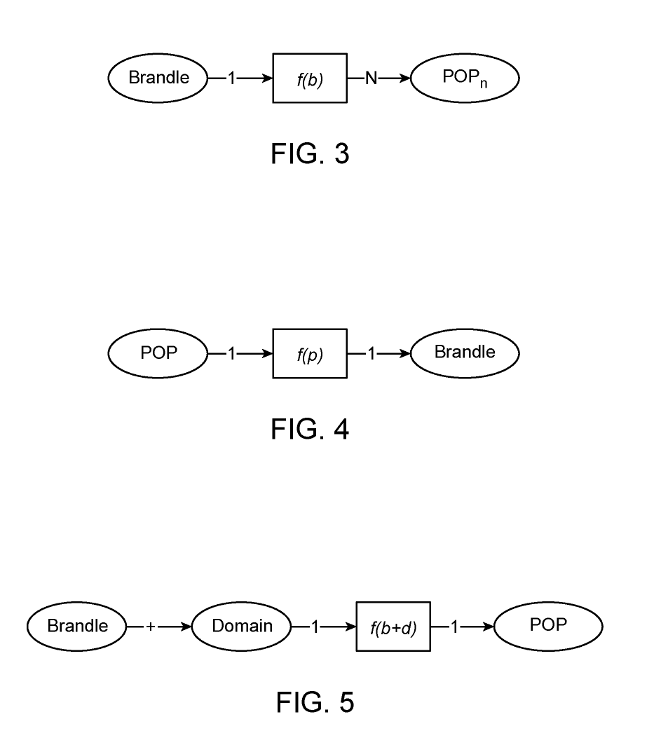

Such a database, therefore, establishes an interne identifier to entity or entity identifier relationship, as illustrated in FIG. 2. This relationship is supported via two primary functional transformations as shown in FIG. 3. The inverse function is likewise supported (see FIG. 4).

In this context, it is noted that the database can be used for a user to look up internet identifiers for a given entity. Using the examples in Table 1 as an example, a query that includes an entity identifier “=cisco” and a program represented by an entity identifier “=facebook” will return the Facebook® account, “cisco” or http://www.facebook.com/cisco” of Cisco Systems, Inc. This capability is supported via the functional transformation presented in FIG. 5.

Accordingly, one embodiment provides a method of identifying an internet identifier for an entity, comprising querying a database of the present disclosure with an entity or a corresponding identifier, along with a domain name or program name, thereby retrieving the internet identifier of the entity associated with the domain name or program name.

In some embodiments, each of the internet identifiers in the database is verified to be associated with the entity. In one aspect, the verification is manually done by a human. In another aspect, the verification is through internet-based verification methods. For instance, the relationship can be validated by employing a standard authorization protocol (e.g., oAuth) to ensure ownership.

in some embodiments, the database further comprises, for one of more of the entity identifiers, one or more non-internet identifiers. Examples of such non-internet identifiers include, without limitation, phone numbers, physical addresses, and Post Office Box addresses. Inquiry can be made to obtain such non-internet identifiers as well from the database, as described, above.

### Entity Identifier Family Tree

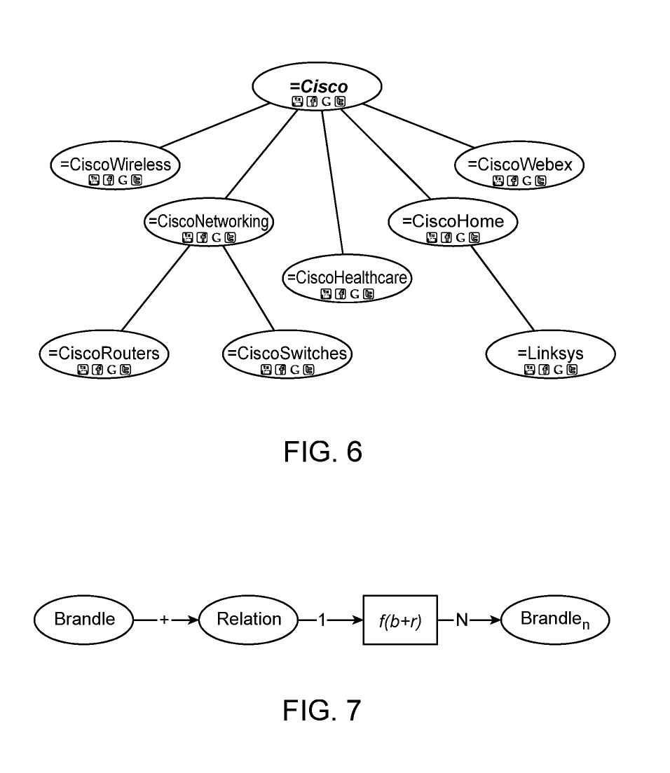

Once an entity identifier (Brandle) is established, a Brandle family can be generated to include the Brandle and affiliate Brandles representing entities related to the corresponding entity. Such a Brandle family can include, for instance, parent and child Brandles, as illustrated in FIG. 6.

Entities related to the corresponding entity can include, for example, internally related entities and externally related entities. A division, subsidiary, certification program, product, plus product line, brand, geographic organization unit etc can be considered internal and thus part of the entity identifier family tree.

On the other hand, a business partner, a contractor, a consultant, a supplier, or a certified person/entity of an entity can be considered an external, which can have their own family trees but can be connected to corresponding entity.

In some embodiments, for instance, an employee (or employment status) can be either “internal” or “external” depending on how the business chooses to manage or represent its relationships with its employees. Some may decide they will create sub-identities that the company “owns” that do no go with the employee when s/he terminates employment. Those are “internal” and thus part of the corporate family tree (e.g. company properly). Other companies may decide they just want to extend the “employee” relationship to the employee but not “own” the identity. This is “external” and the when the company and employee part ways, the relationship is terminated but the employee keeps the identity since she is the owner.

Entities related to the corresponding entity can include, for example, a division or subsidiary of the corresponding entity', a business partner of the corresponding entity, an employment status at the corresponding entity, a certification program of the corresponding entity, or a product of the corresponding entity, without limitation.

Such affiliation relationships can be supported via the functional transformation of FIG. 7.

Once a Brandle (and/or its family tree) has been defined, the database supports the extension of relationships beyond the local family tree. A relationship is defined between two Brandles and is extended from one Brandle to another Brandle to represent that the receiving Brandle has an official relationship with the extending Brandle. Just as in building the local family tree, this capability is built upon the functional transform shown in FIG. 7.

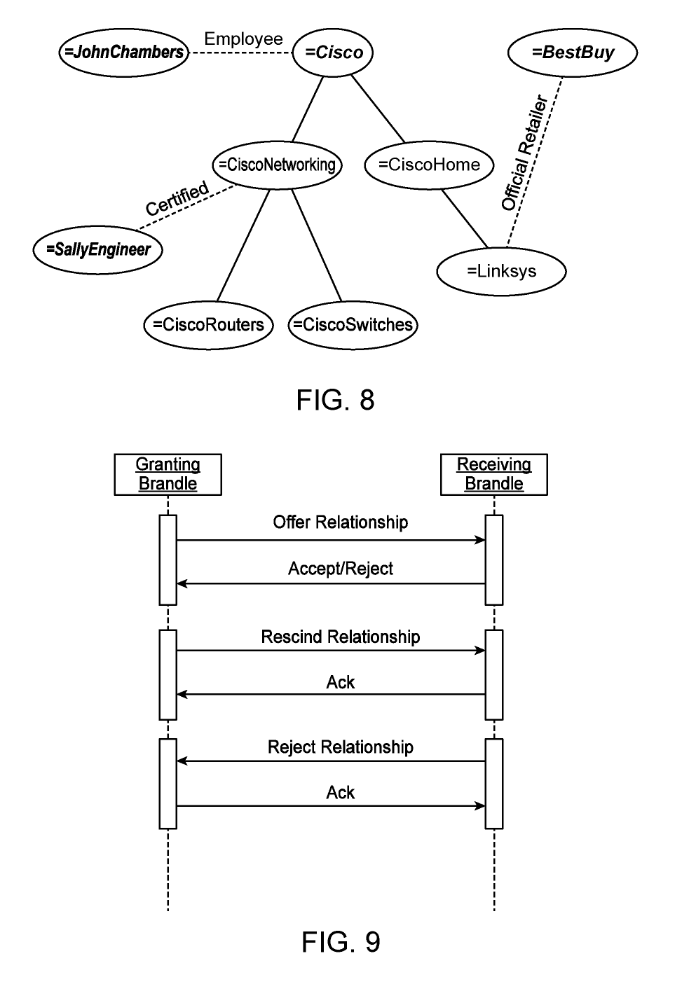

In this case the relationship that is defined is an external one to a foreign Brandle. In the example as shown in FIG. 8, the “employee” relationship is defined and extended by =Cisco to the Brandle that is =JohnChambers, while the person identified as SallyEngineer has been granted a “certification” by the =CiscoNetworking sub-Brandle and =BestBuy has been declared (and accepted) the “Official Retailer” endorsement of the =Linksys sub-Brandle (e.g. brand).

The relationships described herein can be supported via a protocol via the Brandle system to extend, accept, reject, and revoke a relationship, as illustrated in FIG. 9.

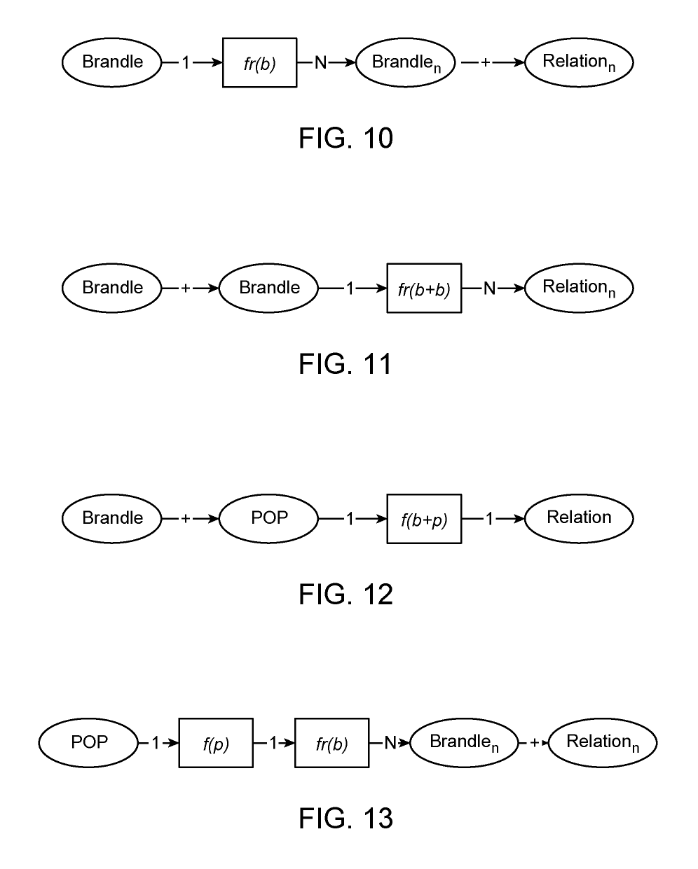

Any relationship which is extended to a foreign Brandle can be validated against the foreign Brandle or any point of presence (POP) of that Brandle. The former, Brandle certification, is supported via functional transformations as shown in FIGS. 10 and 11. The latter, POP certification, can be explicitly supported via the functional transformation of FIG. 12. Plus the latter can be ascertained via the chaining of two functional transformations (FIG. 13).

These functional transforms ensures that, given any point of presence on the web to which foreign Brandles (i.e., individuals or entities), the given POP and its containing Brandle has a relationship, assuming such a relationship has been defined, extended and accepted.

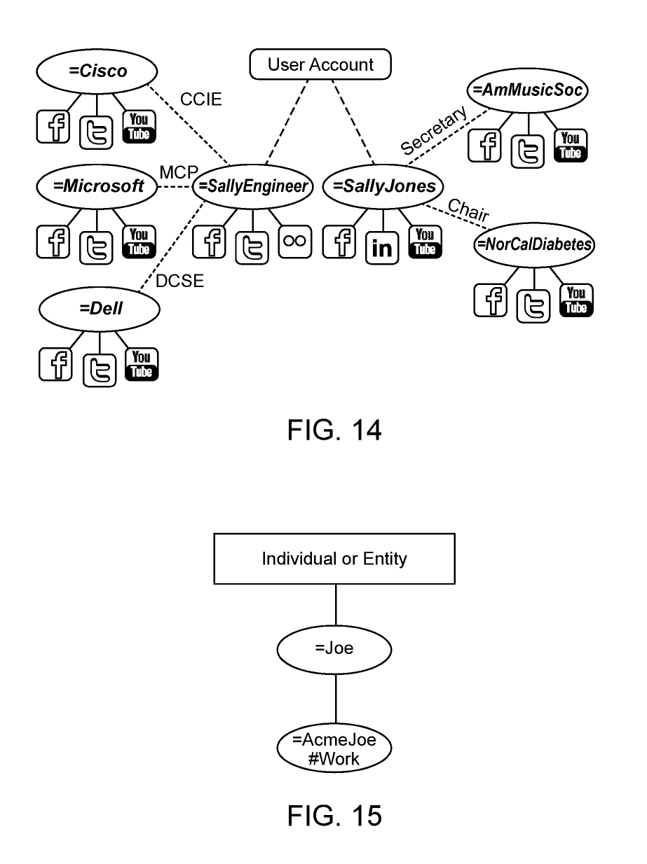

In some embodiments, an entity can create and possess multiple, unrelated Brandles. This allows for the separation of distinct persona, each with their own relationship sets, where appropriate (see, e.g., FIG. 14).

In some embodiments, the database's persona management is configured to utilize sub-Brandles as “related” or “relative” personae. This is achieved by defining sub (or child) Brandles and then assigning them a unique modifier, called a hash modifier, to create a “relative persona” (FIG. 15).

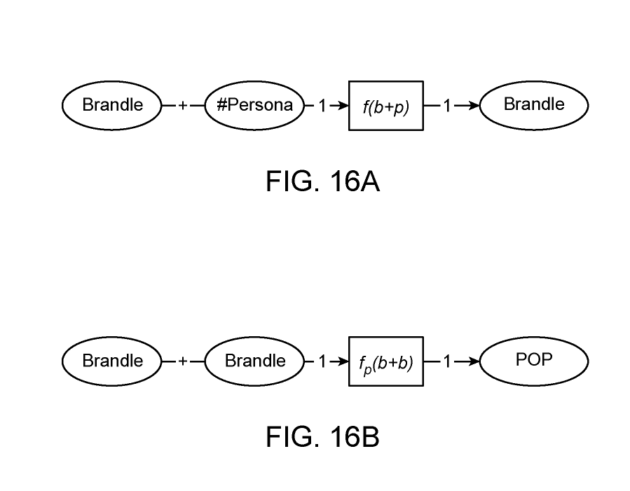

In the example of FIG. 15, =AcmeJoe is a sub-Brandle of Joe with the hash modifier Work. Here, the sub-identity, =Acmejoe can be referenced relative to the parent identity, =Joe, using the hash modifier (#Work). Using this construct, the string “=Joe#Work” can be used as a relative reference to identify the “work persona” of =Joe, which is =Acmejoe. This capability is supported via the functional transformation as shown in FIG. 16A-B.

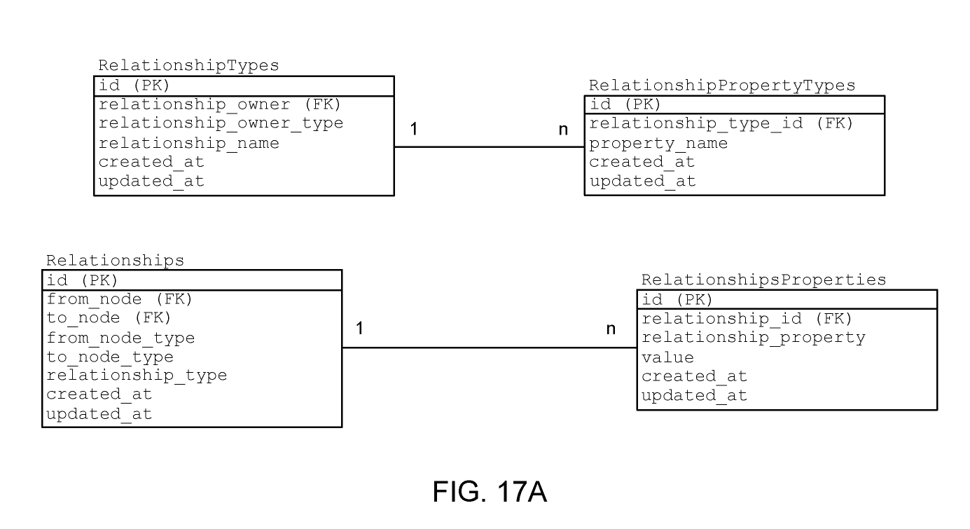

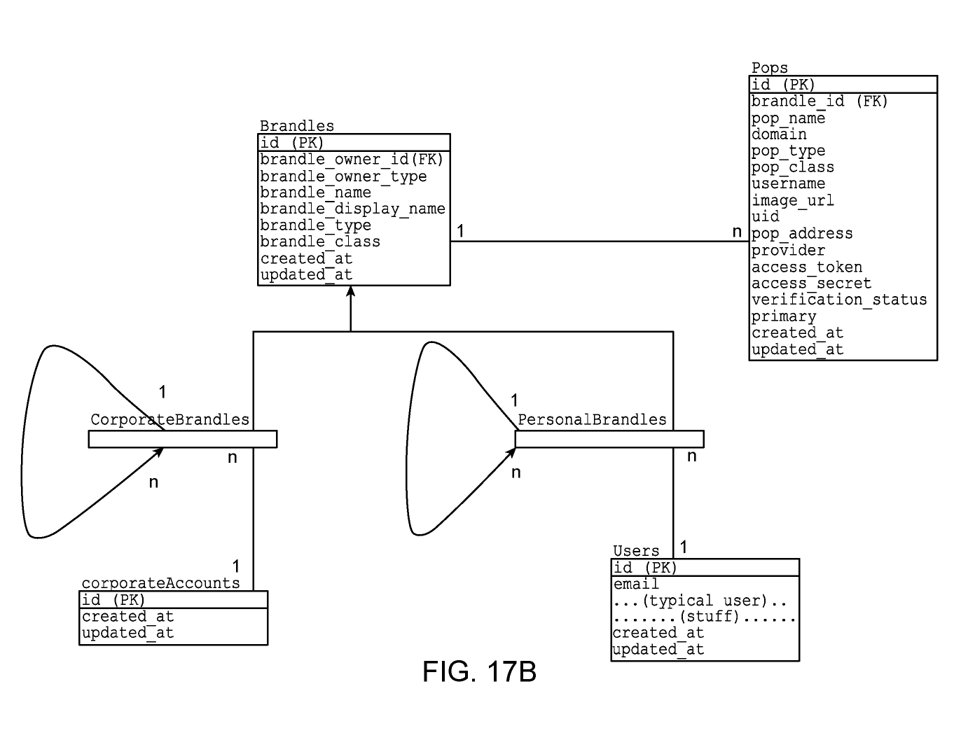

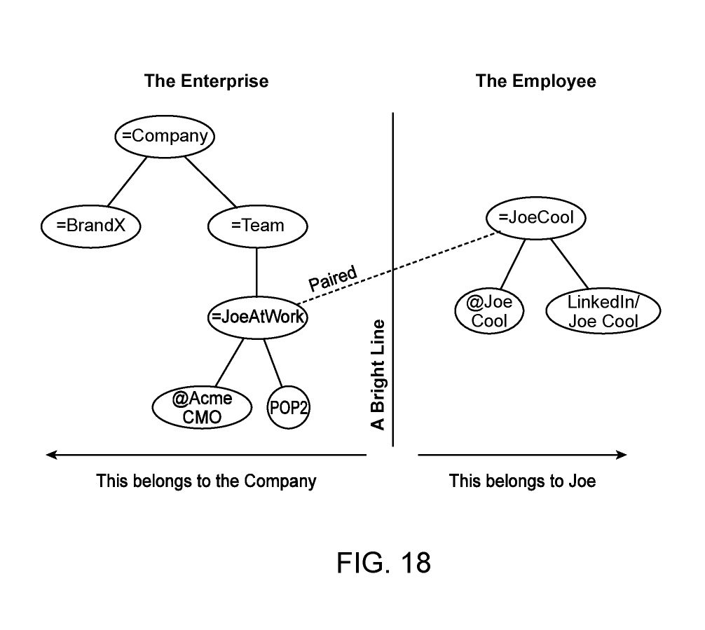

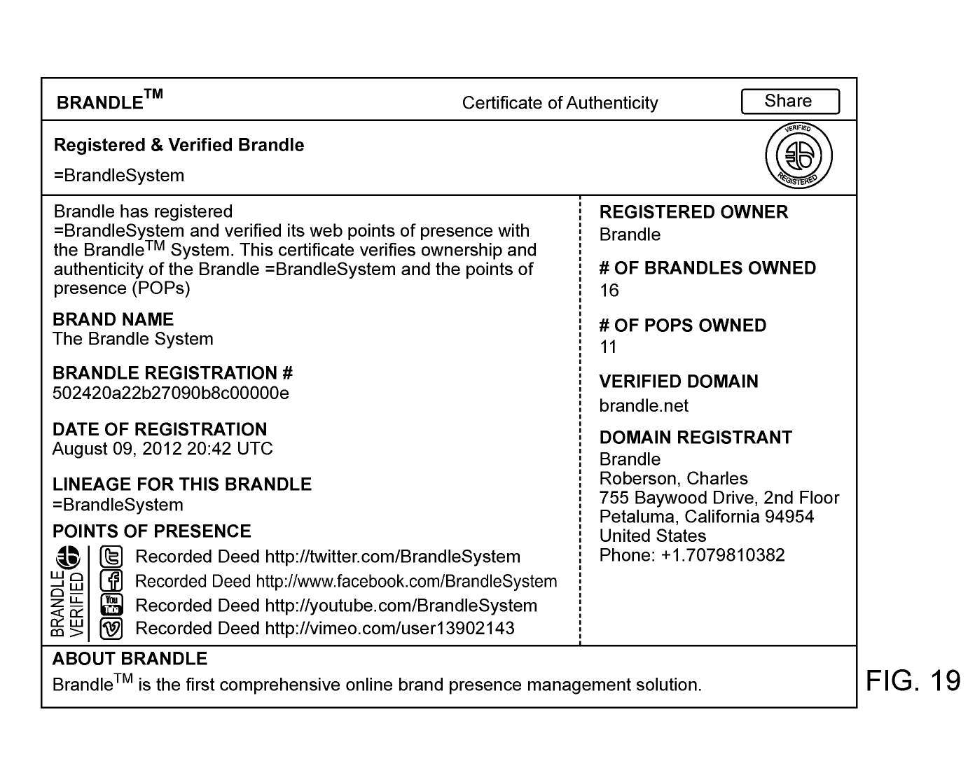

The family trees can also be used to either indicate a real-world relationship or establish such a relationship. One such relationship is ownership. Ownership of a Brandle can be captured by the Brandle Family Tree. Therefore, not only can the system of the present disclosure address the issue of identity integration, unify branding, and relationship management but our structure allows on to make explicit (and facilitate the negotiation of) the ownership of various web assets between employers and employees (see illustration in FIG. 17A-13).

For example, as part of establishing the ownership relationship in the system, an employee can put the password in an escrow account for the company and agrees to keep it current. Conversely, via an authorization protocol (e.g., oAuth), one may be able give the company or the employee the ability to make/break the relationships to various accounts and thus clean-up ownership access after a relationship is broken.

Accordingly, the present disclosure further contemplates a concept of the “password escrow account” by which the system will facilitate the negotiation, explicit representation of that negotiated ownership and then, through the registry, become the source for answering the question: Who “owns” this point of presence on the web.

For example, if one created a “Social_Human” Twitter account and put it in the person's family tree, he is claiming ownership of the account. However, if the person puts it in his company's family tree, he indicates that his company owns it. The password escrow would be a final piece of that to ensure, should he leave the company and that account is in the company's entity identifier family tree, that once the relationship between him and company is broken, it would indicate, via the system, that this account is owned by the company.

In some embodiments, each relationship is expanded to include one or more policies and media assets may come attached to the relationship that the receiving Brandle owner must accept to receive the relationship.

Non-limiting examples of such policies include:

Brandle must not be a sub-Brandle;

Brandle must not have any sub-Brandles;

Brandle may only contain a designated list of POPs (e.g. Twitter and LinkedIn); and

Receiving Brandle agrees to display certain logo, seal, watermark on their POPs where the Brandle system is supported.

### Entity Identifier Pairing (Brandle Pairing)

In some embodiments, an entity (e.g., a person) have multiple entity identifiers (Brandles). For instance, the person (e.g., an employee of a corporation) can have one or more personal Brandles and one or more Brandles owned by the person's employer. Consider the following scenarios:

Case 1—The employee creates a Brandle for the purposes of his or her job. In this situation, one can reasonably argue that the Brandle should be company property and therefore placed in the corporate Brandle family tree.

Case 2—Alternatively, the company could allow the employee to keep the newly created POP as personal property and in that case, it should be recorded as personal property.

Case 3—Finally, there is the case where an employee comes to a company with an existing set of Brandles that bring value to the role he or she performs to the company. Both parties have an interest in sharing this “personal brand equity” with the company without the employee losing control (i.e., ownership) of the Brandles.

The present technology provides mechanism for addressing the challenges presented by cases 2 and 3. The mechanism is illustrated in FIG. 18, which shows that the personal Brandles can optionally form a Brandle family tree, and the Brandle owned by the employer is part of a Brandle family tree owned by the employer.

In one embodiment, a connection is made in the system or database that pairs a person's personal Brandle or personal Brandle family tree to the person's employer's Brandle family tree, as illustrated in FIG. 18. Such a connection can be in the form of a relation in a database, or an annotation in an appropriate Brandle or Brandle family tree. With such a pairing connection, then, the Brandle system would be able to ascertain alleged relationship between different Brandles or Brandle family trees. Further, when such a relationship changes, the pairing can be deleted or updated.

During the pairing process, an administrator starts with enabling the relevant Brandle family tree for pairing, for the entire tree or in a specific division. Once enabled, the administrator configures which Brandle platforms (Brandle service provider, e.g., Twitter, Facebook, etc.) may be paired with the corporate Brandle. As used herein, the term “paired” refers to the creation of a relationship in which the associated Brandle is not owned by the owner of the Brandle family tree; that is, the Brandle is not inserted into the Brandle family tree.

Brandle pairing, in one aspect, is bi-directional, which means when one examines either Brandle, he or she sees that the Brandle in question is paired with the other. However, the association of a Brandle, in some aspects, is uni-directional in that personal Brandles may be displayed as “associated Brandles” on the corporate Brandle but not vice-versa. In this context, it is contemplated that personal Brandles are generally longer-lived, persisting as long as the person so chooses. However, corporate Brandles for employees may only persist for as long as the person is an employee. One objective of Brandle pairing is to allow an employee to share the personal brand equity he or she has amassed in social media with his or her work “persona”. In the same vein, in some aspects, a corporate Brandle can be a work person, associated with a name (e.g., =BillAtDell) or associated with a corporate role (e.g., =DellCMO).

In some aspects, a personal Brandle can be paired with only one corporate Brandle but the system reserves the option to allow a personal Brandle to be paired with more than one corporate Brandle. A corporate Brandle may be paired with one and only one personal Brandle, in one aspect.

Once Entity Pairing is enabled for an entity, tree or division, an administrator would enable Brandle Pairing for an employee's specific corporate Brandle and identify a user in the Brandle System who can pair a personal Brandle to this corporate Brandle. If the user does not exist in the Brandle System, he or she may be invited to join the Brandle System utilizing the normal user invitation process.

To complete the pairing, the identified user can have or create a user account in the Brandle System, create a personal Brandle and accept the pairing offer from the corporate entity. In one aspect, upon completion of pairing, the corresponding entity administrator(s) is/are notified.

Existing pairing can also be disabled or modified at either Brandle at any time. In one aspect, if the company enables a new platform for association, all employees with paired Brandles are notified of the option to associate this new Brandle. If the company disables an existing platform for association, all employees with paired Brandles that associate a Brandle from that platform are notified that the association has been removed. Once an existing pairing is changed, all members of the associated platform are updated accordingly.

### Entity Identity (Brandle) Asset and Attribute Management

In some embodiments, the database can further include assets for each entity identifier. For example, the database can retrieve logos and/or avatars plus color schemes and backgrounds from each interact identifier (POP) for comparison to each other and to a standard reference. Each image can be watermarked, versioned, and catalogued. With such information in the database, an entity can choose to publish a common set of attributes (e.g. imagery and settings) to each POP to establish a more uniform appearance. Such assets, in some embodiments, can also be used to show authenticity of a POP by displaying it on the POP.

### Authentication

As provided, the database of the present disclosure can be used to authenticate an internet identifier, or point of presence (POP), such as a domain name, an internet address, a social network account, a program account or an email account, without limitation. In one embodiment, an authentication request is received at a server to query to the database. In one aspect, the query includes a query internet identifier. The server can then determine, from the database, whether the query internet identifier matches one of the internet identifiers in the database. Further, if there is a match, the server can identify the associated entity or entity identifier. Moreover, the server can return a result showing such results.

In some embodiments, the query is automatically generated at a POP. For instance, an icon or a link can be included on a webpage shown on a URL. A user that visits the webpage can click on the icon or the link, which automatically generates a query and sends the query to the database for the purpose of authentication.

In some embodiments, the POP can automatically sends queries to the database, without the need of a user to request it. Then, if the authentication is successful, the POP displays a visual sign, such as a logo, an icon, or an avatar, e.g., from a Brandle's imagery asset, that can be watermarked or versioned. Therefore, the POP automatically shows to a visitor that it has been authenticated. In one aspect, such queries are generated on a periodic basis.

In some embodiments, the queries are generated within the content (e.g., html content of a webpage). In some embodiments, the queries are generated by a plug-in or extension of the program that displays the content of POP, such as an internet browser, an independent internet program, or a smart phone application. Accordingly, success or failure of the authentication query can be displayed on the program, such as on the status bar, tool bar, or notification center of the program.

In some embodiments, the queries are generated by an extension to a web browser. In addition to preparing authentication queries, the extension can also indicate if there are any relationships extended to the Brandle the associated POP represents. If so, there can be “relationship” symbol with a link to the Brandle register page where one could review those relationships.

Accordingly, the present disclosure further provides, in one embodiment, systems and program products for providing such automatic queries. In one embodiment, provided is a computer-readable non-transitory medium comprising program code which, when executed, displays a link in a web content, wherein the web content is presented in an internet program and is identified by an internet identifier and wherein the link is configured to send an inquiry to determine whether the internet identifier is associated with a real world entity.

Another embodiment provides computer-readable non-transitory medium comprising program code which, when executed, configures a program to determine whether a web content identified by an internet identifier is associated with a real world entity. In one aspect, the program displays the web content.

In some embodiments, the program is configured to send an inquiry to a database of the present disclosure.

Systems are also provided, which comprise a processor, a memory and program code which, when executed by the processor, carried out the above-described functions.

### Ownership Registry and Registry Management

Individuals and businesses sometimes have multiple online accounts (internet identifiers or POPs) created by themselves or by another party. Not only is it difficult to clarify which POPs are authentic but it can be unclear who actually owns these POPs. One example involves POPs of an employee of a company in which it is not clear to either party who owns the POPs and the contacts and the content associated with POPs.

The present disclosure provides methods to authenticate and verify ownership of the POPs. In one embodiment, provided is a POP deed that designates the ownership of a POP. In this context, a Brandle certification is generated for purpose of authentication. Both POP deeds and Brandle certifications can be included in a “Brandle Registry.”

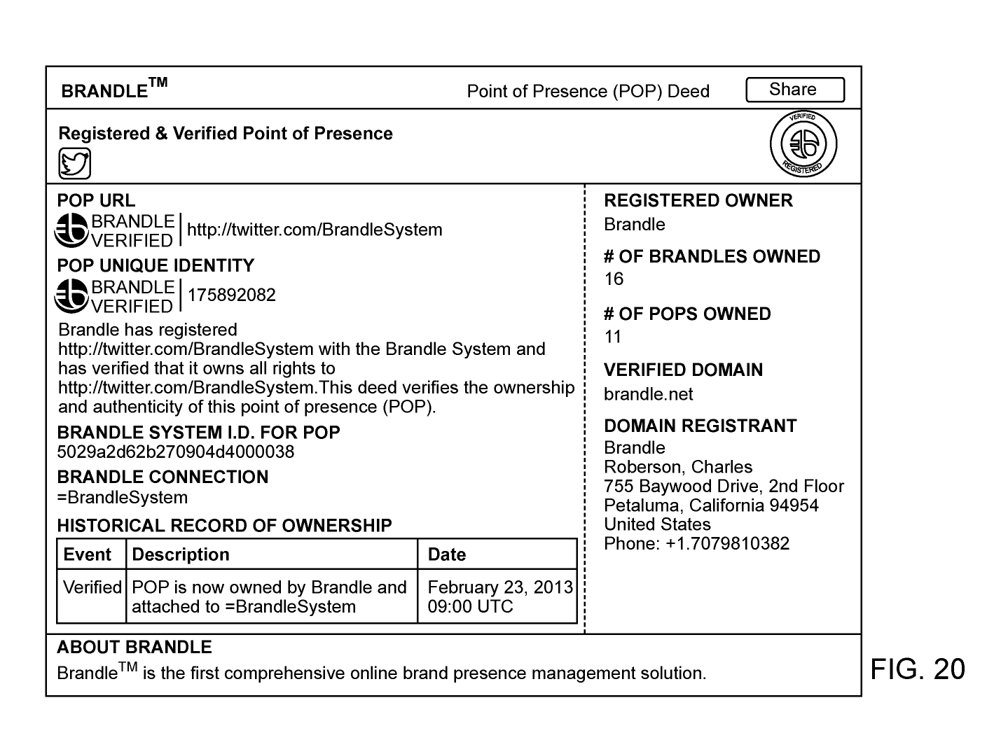

In a Brandle registry, a Brandle certificate (illustrated in FIG. 19) links the Brandle to the owning entity (e.g., via the domain and its DNS Registrant record). A Brandle certificate can then link the Brandle to the POPs that represent that identity or brand. In some aspects, each POP has a POP deed (illustrated in FIG. 20) which records its current and previous ownership by linking to the owning entity. Each POP deed can also relate the POP to its containing Brandles and through that Brandle to its sibling POPs. Therefore, ownership and relationship which are defined in the Brandle system can be represented in the Brandle registry via Brandle certificates and the POP deeds.

Thus, in accordance with one embodiment of the present disclosure provides a Brandle system that employs a Brandle registry to prevent this problem by offering a mechanism by which companies can draw a bright line between what belongs to the company and what does not.

For instance, a representative of a real world entity (e.g., a business) creates an “entity account” for the entity in the registry which includes Brandles and Brandle family trees. All Brandles created by the entity can be included in the family tree. Employees, agents and other entities related to the entity can be invited by an entity administrator, which is discussed in more detail below.

All such employees and agents, upon joining the family tree, should accept a general policy that all Brandles in the Brandle family tree are properties of the Brandle family tree owner (e.g. the business).

Likewise, in a related but different matter, any individual that joins a Brandle in a Brandle family tree, in one aspect, should verify control, and thus ownership, of that the associated POPs. By such joining, the individual explicitly assigns ownership of the Brandle to the owner of the Brandle family tree. It is to be understood that all Brandles in an entity family tree, in some aspects, belong to the company. The same can be true for any POP. Moreover, a POP does not have to be in a Brandle Family tree to be owned by the entity. This can happen by a POP being assigned/attached to a Brandle and then later detached (e.g. it no longer represents that “brand”) but the company still owns it. In that case, the POP is no longer in the Brandle Family tree but it is the entity's POP inventory

A Brandle can also be detached from a Brandle family tree. Such detachment, however, requires approval by appropriate personnel. Such a process is illustrated as follows:
1. User creates entity and links it to the DNS and the Registrant.
2. User creates a Brandle ownership is established by the act of creation
3. User attaches a POP to a Brandle, to do so he or she must:
   (1) verify ownership and thus control of the POP
   (2) we go through a process of making so nobody else has a claim to that POP (e.g. direct notification and public notice)
   (3) POP is now attached to or contained by the Brandle and is thus owned by the Registrant
   POP->Brandle->Entity->DNS->Registrant
4. An Entity, Tree, Division, Brandle or set of Brandles can be transferred to another entity (e.g. think of a business transaction where a company sells a subsidiary, product line, product to another). Ownership is transferred in this case.
5, A POP can be detached from a Brandle but ownership is retained. The example here is, say, Pepsi decides they don't want to actively manage or publicly show a presence on, say, Facebook®. They don't want to give up ownership because they don't want someone else to get the POP and misuse it but they don't want to actively manage it (e.g. they don't want Coke to start posting parodies on it). Basically, they want to own and park the POP like companies do with domains. In this case, the POP is not published as part of the of the Brand Family Tree (e.g. the POP does not show up on a Brandle Certificate but ownership, in the form of a POP Deed is retained).
6. Subsequently, a POP can be abandoned and at that time the POP Deed is updated to show that the previous owner has relinquished all claims of ownership and it's available for acquisition by a new owner.

Information about the Brandle family tree, joining of new Brandles and any change to the Brandle family tree are all recorded in the registry which in, in one aspect, kept in perpetuity by a Brandle registry service, which can be a public and searchable database.

In addition to such registration, the Brandle registry can also provide a notification service. Thus, a good faith effort can be made to contact any individuals associated with a POP to notify any change of ownership of the POP. In particular, such notification is contemplated should anyone else wish to challenge the ownership or assignment of ownership of the POP.

The public notice, in one aspect, is made via a public service, e.g., Twitter, announcing the assignment of ownership of a POP to a Brandle and thus the owning entity. This is helpful to address the issue that someone else might feel he or she have a claim to ownership. This is to document that public notice was made and he or she had multiple opportunities to be made aware of the assignment.

Further, one embodiment of the present disclosure provide a mechanism to challenge ownership assignment. Ownership assignments may be challenged fir a set period of time after public announcement of the assignment, for instance.

In order to carry out any one or more of the above functions, it is contemplated that the Brandle registry contains information about administrators that have authority to manage the ownership or its changes of a Brandle family tree in a registry.

In one aspect, the registry includes an “Entity team structure” that follows a top-down hierarchy including:

Entity Administrator—has authority over all decisions over Entity and its Trees;

Tree Administrator—has authority over all decisions regarding a single Tree and its Divisions or Brandles;

Division Administrator—has authority over a branch of a Tree and its Brandles; and

Brandle Manager—has authority over one more Brandles, explicitly.

Every user who joins an Entity team, in some aspects, should accept a “contract” stating all Brandles in the tree are the property of the Entity. The POPs that are either in Brandles or just in the entity's inventory of POPs can belong to the entity.

When a Brandle is added into a tree, for instance, such addition goes into a work flow system to be reviewed by an administrator at the next highest level (e.g. Division, Tree or Entity admin). A representative of the Entity may configure the Brandle system to accept the ownership assignment automatically or require review by a superior. If the assignment is accepted, it goes into the public record. If it is rejected (e.g., by a superior) then it does not go into the public registry and the assignment is nullified.

Likewise, when a Brandle is deleted (detached) from a tree, it goes into the work flow system to be approved by an administrator at the next highest level or a peer if no such higher admin exists).

Also, the ownership abandonment can be accepted or rejected by the administrator. If the POP is abandoned, the abandonment is recorded in the public registry but the fact of the previous ownership also remains as a matter of historical record.

With respect to ownership transfer, the transfer of ownership of a Brandle can be within the same tree or between trees. Similarly to ownership assignment and deletion, the transfer should be approved by an administrator at the next highest level (or a peer if no such higher admin exists). The transfer will be recorded in the Brandle registry.

For any change to the ownership of a POP, in one aspect, the registry provides an avenue for any entity to challenge the change. To this end, a web-based interface can be provided that allows other parties with a potential interest in this web property (e.g. a second person who shares access rights to the account) to challenge the change of the ownership.

In some aspects, the Brandle system can require the Brandle assigner to include a password and any other account credentials into a locker for safekeeping. The system would periodically test that the password is still valid and report back to the entity administrators the status of that test or raise an alarm should the credentials no longer work.

In accordance with one embodiment of the disclosure, therefore, the present disclosure further provides a system for managing a family tree of internet identifiers, comprising a processor, memory and program code which, when executed by the processer, configures the system to receive a request to insert a first Internet identifier into a family tree, wherein the family tree comprises (a) a plurality of leaves each denoting an Internet identifier which represents a real world entity, and (b) edges connecting the internet identifiers each representing a real world relationship between the connected Internet identities, send an electronic notification to an administrator for approval of insertion of the first internet identifier to the family tree; and insert the first internet identifier to the family tree as a new leaf after the administrator approves the insertion.

In one aspect, the system is further configured to record the insertion in a public database. In another aspect, the system is further configured to display information about the insertion on the web. In yet another aspect, the system is further configured to: receive a request to delete a second interim identifier that is in the family tree from the family tree; send electronic notification to the administrator for approval of the deletion; and delete the second internet identifier from the family tree after the administrator approves the deletion.

### Entity Account

One embodiment of the present disclosure provides an entity account for a Brandle owner, which can facilitate management of Brandles and family trees, as well as authentication of activities related to the Brandles. In one aspect, an entity account is associated with a domain that is used to send and receive entails.

Creation of an entity account, in one aspect, can start with creation of a user account for a user that wishes to create an entity account in the Brandle system. It can be required that the user have an email address that has been verified with the Brandle system.

In one aspect, when the user, having a user account, creates an entity account, the user can be asked to select an email from a list of emails verified by the system. Alternatively, the user can opt to add and verify a new email address at a new domain. Once the user enters an email associated with a domain, the system then looks up the Whois database to verify the relationship between the domain and the entity relating to the Brandles. The Whois database is the public search interface to look up information about a domain in the DNS. The Whois database, for instance, contains information for a domain like illustrated in the table below.

| | |
|---|---|
| Domain Name: | DELL.COM |
| [REGISTRANT] | |
| Organisation Name: | Dell Inc. |
| Contact Name: | Dell Domain Administrative Contact |
| Address Line 1: | 1 Dell Way |
| Address Line 2: | RR1-33 |
| City/Town: | Round Rock |
| State/Province: | Texas |
| Zip/Postcode: | 78682 |
| Country: | US |
| Telephone: | +1.5127283500 |
| Fax: | +1.5122833369 |
| Email: | dnsadmin@dell.com |

Subsequently, in some aspects, the system can send a notice to the Whois domain registrant to notify that an entity account has been created for a POP associated with the domain. Unless rejected by the domain registrant in a timely fashion, an entity account will be created as requested.

In some embodiments, the system requires a multi-stage verification process to build the chain of pedigree of Brandles, authenticity and ownership from a POP to a Brandle and to a tree of Brandles. It is contemplated that, in some aspects, embodiment of the registry and the authenticity and ownership it reflects depends on the underlying Brandle System.

In one aspect, a Brandle is placed under another, which results in a pedigree. Further, in another aspect, one can anchor a Brandle family tree to a domain (and thus verifying control of that domain), thus completing the pedigree from POP to Brandle to tree to domain. These steps would help clarify ownership. That is, if the anchor and the owner domains are the same, the chain is verified and complete. If neither the domains nor the registrants are the same then the system, in one aspect, can ask the user to update the Whois records.

### The Registry Certificate

One embodiment of the disclosure envisions a registry certificate for a Brandle owner. In some aspects, the certificate can include the following information:
Brandle Information
Owned by: (if available)
Authenticated to: (if available)
POPs integrated into this Brandle
Pedigree (Brandle Tree)
Historical Log

### Agencies

An agency is one that can manage a Brandle on behalf of a Brandle owner. In order to become an agency, one should get a proxy by sending an email to the customer at that company requesting authority to create an entity account using their domain. This would work as follows.

To start, the agency user should have a user account. In this case the agency user does not have a verified email at the entity (i.e., company) to be created. When the user goes to create the entity account, the system can provide a third option, “I'm an agent/agency working on behalf of another company.” If the user selects that option, the system can have the user enter the email address of someone at that domain who will authorize the creation. In one aspect, warnings can be displayed, e.g. “the system will log that you requested this proxy, record who gave you the proxy and we will notify the DNS registrant.”

### Fraud Detection

As provided above, media assets associated with entities can be catalogued into the database. Thus, the system can monitor for consistent and detect unauthorized use of those assets both inside and outside of the Brandle family tree. By having the assets catalogued and linked to specific Brandles, one can determine when and where specific assets are explicitly authorized to be utilized. Anything outside that authorized space, can be detected and reported to the Brandle owner for investigation.

In another embodiment, a server can be configured to inspect internet identifiers for potential fraud. The content of an internet identifier may display image or text that designates its affiliation with an entity. The server can then capture the internet identifier and the designated entity name and cheek them against the database. If the internet identifier does not exist in the database whereas the entity name does, then a potential fraud is detected.

Accordingly, in one embodiment, the present disclosure provides a method for detecting web content falsely associated with a real world entity comprising scanning, by a server, a web content self-identifying as associated with a designated real world entity; checking the internet identifier associated with the web content against a database of the present disclosure; determining that the web content falsely identifies itself as associated with the designated real world entity if the designated real world entity matches a real world entity in the database but the internet identifier associated with the web content is not associated with the designated real world entity in the database.

### Computer Network

It will be appreciated by the knowledgeable reader that the methods of the present disclosure can be implemented on any computer network. Methods and devices for providing network data transmission are well known in the art.

Embodiments can include program products comprising non-transitory machine-readable storage media for carrying or having machine-executable instructions or data structures stored thereon. Such machine-readable media may be any available media that may be accessed by a general purpose or special purpose computer or other machine with a processor. By way of example, such machine-readable storage media may comprise RAM, ROM, EPROM, EEPROM, CD-ROM or other optical disk storage, magnetic disk storage or other magnetic storage devices, or any other medium which may be used to store desired program code in the form of machine-executable instructions or data structures and which may be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, logics, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed and cloud computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

It should be noted that although the discussions herein may refer to a specific order and composition of method steps, it is understood that the order of these steps may differ from what is described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

Unless otherwise defined, all technical and scientific terms used herein have the same meaning as commonly understood by one of ordinary skill in the art to which this invention belongs.

The inventions illustratively described herein may suitably be practiced in the absence if any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed.

Thus, it should be understood that although the present invention has been specifically disclosed by preferred embodiments and optional features, modification, improvement and variation of the inventions embodied therein herein disclosed may be resorted to by those skilled in the art, and that such modifications, improvements and variations are considered to be within the scope of this invention. The materials, methods, and examples provided here are representative of preferred embodiments, are exemplary, and are not intended as limitations on the scope of the invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

In addition, where features or aspects of the invention are described in terms of Markush groups, those skilled in the art will recognize that the invention is also thereby described in terms of any individual member or subgroup of members of the Markush group.

All publications, patent applications, patents, and other references mentioned herein are expressly incorporated by reference in their entirety, to the same extent as if each were incorporated by reference individually. In case of conflict, the present specification, including definitions, will control.

It is to be understood that while the disclosure has been described in conjunction with the above embodiments, that the foregoing description and examples are intended to illustrate and not limit the scope of the disclosure. Other aspects, advantages and modifications within the scope of the disclosure will be apparent to those skilled in the art to which the disclosure pertains.

1. A method for authenticating a query internet identifier, comprising:
receiving, at a server, an inquiry comprising a query internet identifier,
checking the query internet identifier against a database that (a) comprises a plurality of entity identifiers each representing a real world entity and (b) associates each of the plurality of entity identifiers to at least an internet identifier
determining whether the query internet identifier matches one of the internet identifiers in the database.

2. The method of claim 1, further comprising returning a result indicating that the query internet identifier matches an internet identifier in the database thereby authenticating the query internet identifier as associated with the corresponding real word entity.

3. The method of claim 1, wherein the inquiry is generated by a user clicking on a link displayed in a web content identified by the query internet identifier.

4. The method of claim 1, wherein the inquiry is generated by a program that displays a web content identified by the query internet identifier.

5. The method of claim 4, wherein the program is an internet browser or a smart phone program that is capable of generating the inquiry to be sent to the server.

6. The method of claim 1, wherein the internet identifier is selected from the group consisting of a social network account, a domain name, a URL address and an email address.

7. The method of claim 1, wherein each internet identifier has been verified to be associated with the entity identifier.

8. The method of claim 1, wherein at least one of the plurality of entity identifiers has an associated affiliate entity identifier and the database comprises at least an internet identifier associated with the affiliate entity identifier.

9. The method of claim 8, wherein the affiliate entity identifier represents one or more selected from the group consisting of:
a division or subsidiary of the corresponding entity,
a business partner of the corresponding entity,
an employment status at the corresponding entity,
a certification program of the corresponding entity, and
a product of the corresponding entity.

10. A system for authenticating a query internet identifier, comprising a processor, memory and program code which, when executed by the processor, configures the system to:
receive an inquiry comprising, a query internet identifier,
check the query internet identifier against a database that (a) comprises a plurality of entity identifiers each representing a real world entity and (h) associates each of the plurality of entity identifiers to at least an internet identifier
determine whether the query internet identifier matches one of the internet identifiers in the database.

11. A non-transitory computer-readable storage medium comprising program code which, when executed,
receives an inquiry comprising a query interact identifier,
checks the query internet identifier against a database that (a) comprises a plurality of entity identifiers each representing a real world, entity and (b) associates each of the plurality of entity identifiers to at least an internet identifier
determines whether the query internet identifier matches one of the internet identifiers in the database.

12. A non-transitory computer-readable storagemedium comprising program code which, when executed, displays a link in a web content, wherein the web content is presented in an interact program and is identified by an internet identifier and wherein the link is configured to send an inquiry to determine whether the internet identifier is associated with a real world entity.

13. A non-transitory computer-readable storage medium comprising program code which, when executed, configures a program to determine whether a web content identified by an internet identifier is associated with a real world entity.

14. The medium of claim 13, wherein the program displays the web content.

15. The medium of claim 12, wherein the program is configured to send an inquiry to a database that (a) comprises a plurality of entity identifiers each representing a real world entity and (b) associates each of the plurality of entity identifiers to at least an interact identifier.

16. A method for detecting web content falsely associated with a real world entity comprising:
scanning, by a server, a web content self-identifying as associated with a designated real world entity;
checking the internet identifier associated with the web content against a database that (a) comprises a plurality of entity identifiers each representing a real world entity and (b) associates each of the plurality of entity identifiers to at least an internet identifier;
determining that the web content falsely identifies itself as associated with the designated real world entity if the designated real world entity matches a real world entity in the database but the internet identifier associated with the web content is not associated with the designated real world entity in the database.

17. A system for managing a family tree of internet identifiers, comprising a processor, memory and program code which, when executed by the processer, configures the system to:
receive a request to insert a first internet identifier into a family tree, wherein the family tree comprises (a) a plurality of leaves each denoting an internet identifier which represents a real world entity, and (b) edges connecting the internet identifiers each representing a real world relationship between the connected internet identities;
send an electronic notification to an administrator for approval of insertion of the first internet identifier to the family tree; and
insert the first internet identifier to the family tree as a new leaf after the administrator approves the insertion.

18. The system of claim 17, wherein the system is further configured to record the insertion in a public database

19. The system of claim 17, wherein the system is further configured to display information about the insertion on the web.

20. The system of claim 17, wherein the system is further configured to:
receive a request to delete a second internet identifier that is in the family tree from the family tree;
send an electronic notification to the administrator for approval of the deletion; and
delete the second internet identifier from the family tree after the administrator approves the deletion.
